(19) United States
(12) Patent Application Publication
(10) Pub. No.: US 2021/0312583 A1
(43) Pub. Date: Oct. 7, 2021

(54) CONTROL DEVICE, PROGRAM FOR CONTROL DEVICE, AND PROGRAM FOR TERMINAL DEVICE

(71) Applicant: TOYOTA JIDOSHA KABUSHIKI KAISHA, Toyota-shi (JP)

(72) Inventor: Daiki KANEICHI, Shinagawa-ku (JP)

(73) Assignee: TOYOTA JIDOSHA KABUSHIKI KAISHA, Toyota-shi (JP)

(21) Appl. No.: 17/212,112

(22) Filed: Mar. 25, 2021

(30) Foreign Application Priority Data
Apr. 6, 2020 (JP) 2020-068305

(51) Int. Cl. G06Q 50/30; G06Q 10/02; G06Q 10/08; G06Q 30/02; G06Q 50/00

(52) U.S. Cl. CPC G06Q 50/30; G06Q 10/02; G06Q 50/01; G06Q 30/0282; G06Q 10/0832

(57) ABSTRACT

A control device includes a communication unit and a control unit. The communication unit communicates with a terminal device. The control unit transmits vehicle allocation information for proposing allocation of at least one of a pickup vehicle for transporting a user to a facility and a delivery vehicle for delivering a product from the facility to the terminal device via the communication unit based on contribution information which is contributed to a social networking service and a response from a user of the terminal device to the contribution information.

### CROSS-REFERENCE TO RELATED APPLICATION

This application claims priority to Japanese Patent Application No. 2020-068305 filed on Apr. 6, 2020, incorporated herein by reference in its entirety.

### BACKGROUND

### 1. Technical Field

The present disclosure relates to a control device, a program for a control device, and a program for a terminal device.

### 2. Description of Related Art

A technique of identifying a store of a product which is desired by a user based on a comment input by the user and proposing delivery of the product to the user is described in Japanese Unexamined Patent Application Publication No. 2017-187920 (JP 2017-187920 A).

### SUMMARY

Recently, there have been requirements for additional improvements in serviceability of a vehicle allocation technique.

The present disclosure provides a control device, a program for a control device, and a program for a terminal device that can improve serviceability of a vehicle allocation technique.

A control device according to an embodiment of the present disclosure includes: a communication unit configured to communicate with a terminal device; and a control unit configured to transmit vehicle allocation information for proposing allocation of at least one of a pickup vehicle for transporting a user to a facility and a delivery vehicle for delivering a product from the facility to the terminal device via the communication unit based on contribution information which is contributed to a social networking service and a response from the user of the terminal device to the contribution information.

A program according to an embodiment of the present disclosure causes a computer to serve as a control device including: a communication unit configured to communicate with a terminal device; and a control unit configured to transmit vehicle allocation information for proposing allocation of at least one of a pickup vehicle for transporting a user to a facility and a delivery vehicle for delivering a product from the facility to the terminal device via the communication unit based on contribution information which is contributed to a social networking service and a response from the user of the terminal device to the contribution information.

A program according to an embodiment of the present disclosure causes a computer to serve as a terminal device including: a control unit configured to perform control for displaying vehicle allocation information for proposing allocation of at least one of a pickup vehicle for transporting a user to a facility and a delivery vehicle for delivering a product from the facility based on contribution information which is contributed to a social networking service and a response from the user to the contribution information.

With the control device, the program for a control device, and the program for a terminal device according to the embodiments of the present disclosure, it is possible to improve serviceability of a vehicle allocation technique.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a configuration of an information processing system according to an embodiment;

FIG. 2 is a block diagram schematically illustrating a configuration of a vehicle according to an embodiment;

FIG. 3 is a block diagram schematically illustrating a configuration of a terminal device according to an embodiment;

FIG. 4 is a block diagram schematically illustrating a configuration of a control device according to an embodiment;

FIG. 5 is a diagram illustrating an example of an operation of the information processing system according to the embodiment;

FIG. 6 is a diagram illustrating an example of the operation of the information processing system which is subsequent to FIG. 5;

FIG. 7 is a diagram illustrating an example of a screen which is displayed on a terminal device according to an embodiment;

FIG. 8 is a diagram illustrating another example of a screen which is displayed on a terminal device according to an embodiment; and

FIG. 9 is a diagram illustrating another example of a screen which is displayed on a terminal device according to an embodiment.

### DETAILED DESCRIPTION OF EMBODIMENTS

Hereinafter, an embodiment of the present disclosure will be described with reference to the accompanying drawings.

In the drawings, the same or corresponding elements will be referred to by the same reference signs. In description of embodiments, description of the same or corresponding elements will be appropriately omitted or simplified.

### Configuration of Information Processing System

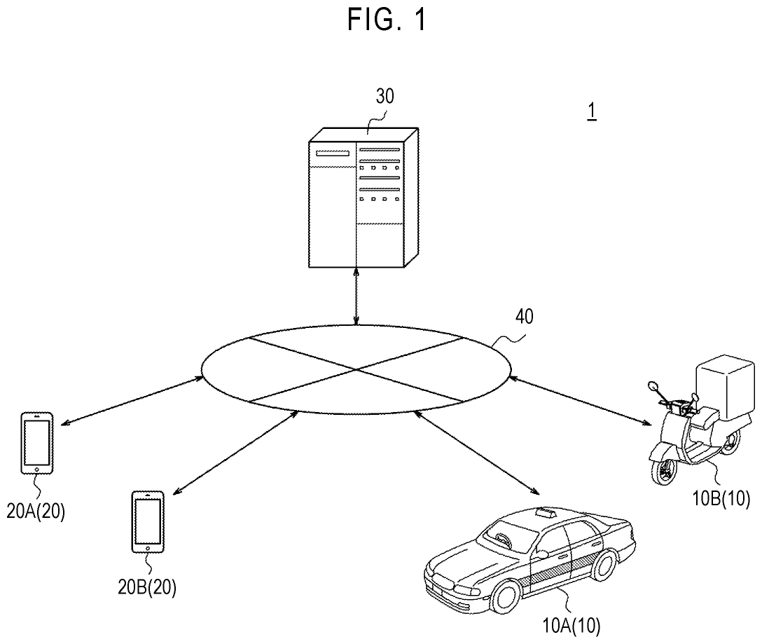

A configuration of an information processing system 1 according to an embodiment will be described below with reference to FIG. 1. The information processing system 1 includes a vehicle 10, a terminal device 20, and a control device 30. In FIG. 1, two vehicles 10, two terminal devices 20, and one control device 30 are illustrated. However, the information processing system 1 may include an arbitrary number of vehicles 10, an arbitrary number of terminal devices 20, and an arbitrary number of control devices 30.

Each vehicle 10 is an arbitrary vehicle that transports at least one of a user and an object such as an on-demand bus, a rented vehicle, a shared vehicle, a taxi, a motorbike, a truck, or a bicycle. The vehicles 10 include a pickup vehicle 10A that is used to transport a user and a delivery vehicle 10B that is used to deliver an object. In this embodiment, it is assumed that the pickup vehicle 10A is a taxi and the delivery vehicle 10B is a motorbike. However, the pickup vehicle 10A and the delivery vehicle 10B may be any vehicles. The pickup vehicle 10A and the delivery vehicle 10B may be the same vehicle or different vehicles. In the following description, the pickup vehicle 10A and the delivery vehicle 10B are collectively simply referred to as vehicles 10 when they are not particularly distinguished. Each vehicle 10 may be driven by a driver or driving thereof may be automated at an arbitrary level. An automation level is, for example, one of levels 1 to 5 in level classifications of the Society of Automotive Engineers (SAE).

Each terminal device 20 is a computer such as a mobile phone, a smartphone, or a personal computer. In this specification, a computer is also referred to as an information processing device. In this embodiment, the terminal devices 20 include, for example, a terminal device 20A that is carried by a user U1 and a terminal device 20B that is carried by a user U2. In the following description, the terminal device 20A and the terminal device 20B are collectively simply referred to as terminal devices 20 when they are not particularly distinguished.

The control device 30 includes one computer or a plurality of computers that can communicate with each other. In this embodiment, the control device 30 provides a social networking service (SNS). In this embodiment, for example, it is assumed that the SNS is a service that allows users to share information by contributing and browsing information including an image or text. However, the SNS may include a service that allows users to share information in an arbitrary manner such as a web site, a blog, or a chat. In the present disclosure, an “image” may be, for example, a still image or a moving image.

The vehicles 10, the terminal devices 20, and the control device 30 can communicate with each other via a network 40. The network 40 is an arbitrary communication network in which the vehicles 10, the terminal devices 20, and the control device 30 can communicate with each other. The network 40 may be a wireless or wired transmission path or a communication network such as the Internet. For example, the network 40 in this embodiment may include an ad hoc network, a metropolitan area network (MAN), a cellular network, a wireless personal area network (WPAN), a public switched telephone network (PSTN), a terrestrial wireless network, an optical network, another network, or a combination of some thereof.

In the information processing system 1, the control device 30 provides a function of contributing and browsing contribution information including an image or text to a user of the SNS. The control device 30 identifies a facility in which a user is interested based on contributed contribution information and a response from a user of the terminal device 20 to the contribution information. The control device 30 generates vehicle allocation information of a vehicle 10 with a position of the identified facility as at least one of a departure place and a destination. In this embodiment, “vehicle allocation information” of a vehicle 10 is information for proposing vehicle allocation of the vehicle 10. The vehicle allocation information of a vehicle 10 includes, for example, a model, the number of occupants, information of a departure place and a destination, a travel route, a scheduled departure time from the departure place, a scheduled arrival time at the destination, a vehicle allocation method, or a charge. For example, the control device 30 may generate vehicle allocation information of a pickup vehicle 10A that transports a user from the position of the user to the position of the facility. The control device 30 may generate vehicle allocation information of a delivery vehicle 10B that delivers a product provided from the facility from the position of the facility to the position of the user. The control device 30 transmits the vehicle allocation information of the vehicles 10 to the terminal device 20. In this embodiment, for example, it is assumed that the facility is a restaurant and a product provided from the facility is food. However, the facility and the product provided from the facility may be arbitrarily determined.

The terminal device 20 communicates with the control device 30 and performs display of contribution information contributed to the SNS and transmission of a response to the contribution information. The terminal device 20 displays the vehicle allocation information of the vehicles 10 which is generated by the control device 30 based on the contribution information and the response to the contribution information along with the contribution information. Accordingly, the user of the terminal device 20 can refer to the vehicle allocation information of the vehicles 10 associated with the contribution information while browsing the contribution information of the SNS and it is possible to improve serviceability of a vehicle allocation technique of the vehicles 10.

The vehicles 10, the terminal devices 20, and the control device 30 which are included in the information processing system 1 will be described below in detail.

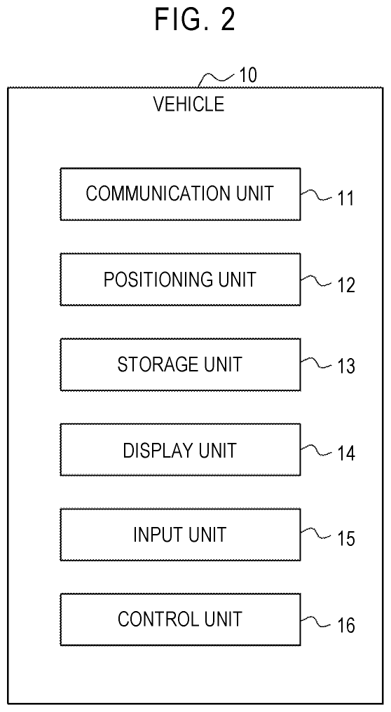

The configuration of a vehicle 10 according to this embodiment will be described with reference to FIG. 2. As illustrated in the block diagram of FIG. 2, the vehicle 10 includes a communication unit 11, a positioning unit 12, a storage unit 13, a display unit 14, an input unit 15, and a control unit 16. The communication unit 11, the positioning unit 12, the storage unit 13, the display unit 14, the input unit 15, and the control unit 16 may be incorporated into the vehicle 10 or may be detachably provided in the vehicle 10. When they are detachably provided in the vehicle 10, the communication unit 11, the positioning unit 12, the storage unit 13, the display unit 14, the input unit 15, and the control unit 16 may be provided in a computer which is detachable from the vehicle 10 such as a car navigation device. The communication unit 11, the positioning unit 12, the storage unit 13, the display unit 14, the input unit 15, and the control unit 16 are communicatively connected to each other in a wired or wireless manner via an onboard network such as a controller area network (CAN) or a dedicated line.

The communication unit 11 includes a communication module for connecting to the network 40. The communication module is, for example, a communication module corresponding to a mobile communication standard such as 4th generation (4G) or 5th generation (5G). The communication module may be, for example, a communication module corresponding to a standard such as a wired local area network (LAN) or a wireless LAN. The communication module may be a communication module corresponding to a short-range radio communication standard such as Wi-Fi (registered trademark), Bluetooth (registered trademark), or infrared communication. For example, an onboard communication device mounted in the vehicle 10 may serve as the communication unit 11. In this embodiment, the vehicle 10 is connected to the network 40 via the communication unit 11. Accordingly, the vehicle 10 can communicate with the control device 30 and the like.

The positioning unit 12 measures a position of the vehicle 10 and generates position information. In this embodiment, “position information” is information for identifying a position. In this embodiment, position information includes, for example, coordinates such as two-dimensional coordinates or three-dimensional coordinates. However, position information is not limited to coordinates and may include a speed, a moving route, a moving distance, or an amount of change or a rate of change thereof. The positioning unit 12 includes a receiver corresponding to a satellite positioning system. The satellite positioning system corresponding to the receiver may be, for example, the Global Positioning System (GPS). The positioning unit 12 may include an acceleration sensor or a gyro sensor. For example, a car navigation device mounted in the vehicle 10 may serve as the positioning unit 12.

The storage unit 13 is, for example, a semiconductor memory, a magnetic memory, or an optical memory. The storage unit 13 may serve as, for example, a main storage device, an auxiliary storage device, or a cache storage device. The storage unit 13 stores arbitrary information which is used for operation of the vehicle 10. For example, the storage unit 13 may store a system program, an application program, and various types of embedded software. For example, information stored in the storage unit 13 may be updated with information which is acquired from the network 40 via the communication unit 11.

The display unit 14 displays information as an image or text. The display unit 14 includes, for example, a display device such as a display. For example, the car navigation device may serve as the display unit 14.

The input unit 15 receives an input operation. The input unit 15 includes, for example, an input device such as a touch panel, a physical key, a camera, a microphone, or an IC card reader. For example, the car navigation device may serve as the input unit 15.

The control unit 16 includes one or more processors. Each processor may be, for example, a general-purpose processor such as a central processing unit (CPU) or a dedicated processor specialized in a specific process. The control unit 16 is not limited to the processor and may include one or more dedicated circuits. Each dedicated circuit may be, for example, a field-programmable gate array (FPGA) or an application specific integrated circuit (ASIC). The control unit 16 controls the constituents in order to realize the function of the vehicle 10 including the functions of the constituents such as the communication unit 11, the positioning unit 12, the storage unit 13, the display unit 14, and the input unit 15.

### Configuration of Terminal Device

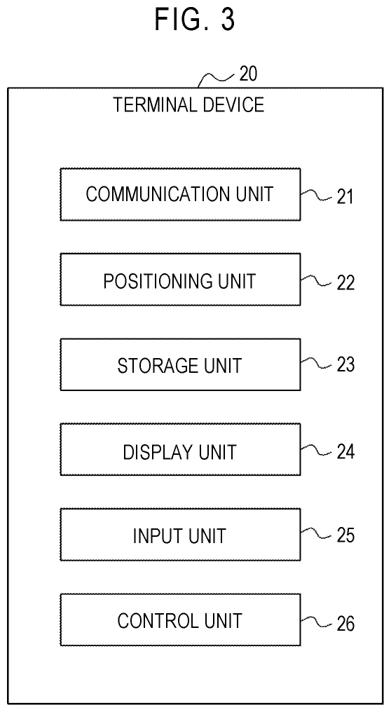

The configuration of a terminal device 20 according to this embodiment will be described with reference to FIG. 3. As illustrated in the block diagram of FIG. 3, the terminal device 20 includes a communication unit 21, a positioning unit 22, a storage unit 23, a display unit 24, an input unit 25, and a control unit 26. The communication unit 21, the positioning unit 22, the storage unit 23, the display unit 24, the input unit 25, and the control unit 26 are communicatively connected to each other in a wired or wireless manner.

The communication unit 21 includes a communication module for connecting to the network 40. The communication module is, for example, a communication module corresponding to a mobile communication standard such as 4G or 5G. The communication module may be, for example, a communication module corresponding to a standard such as a wired LAN or a wireless LAN. The communication module may be a communication module corresponding to a short-range radio communication standard such as Wi-Fi, Bluetooth, or infrared communication. In this embodiment, the terminal device 20 is connected to the network 40 via the communication unit 21. Accordingly, the terminal device 20 can communicate with the control device 30 and the like.

The positioning unit 22 measures a position of the terminal device 20 and generates position information. The positioning unit 22 includes a receiver corresponding to a satellite positioning system. The satellite positioning system corresponding to the receiver may be, for example, GPS. The positioning unit 22 may include an acceleration sensor or a gyro sensor.

The storage unit 23 is, for example, a semiconductor memory, a magnetic memory, or an optical memory. The storage unit 23 may serve as, for example, a main storage device, an auxiliary storage device, or a cache storage device. The storage unit 23 stores arbitrary information which is used for operation of the terminal device 20. For example, the storage unit 23 may store a system program, an application program, and embedded software. For example, information stored in the storage unit 23 may be updated with information which is acquired from the network 40 via the communication unit 21.

The display unit 24 displays information as an image or text. The display unit 24 includes, for example, a display device such as a display.

The input unit 25 receives an input operation. The input unit 25 includes, for example, an input device such as a touch panel, a physical key, a camera, a microphone, or an IC card reader.

The control unit 26 includes one or more processors. Each processor may be, for example, a general-purpose processor such as a CPU or a dedicated processor specialized in a specific process. The control unit 26 is not limited to the processor and may include one or more dedicated circuits. Each dedicated circuit may be, for example, an FPGA or an ASIC. The control unit 26 controls the constituents in order to realize the function of the terminal device 20 including the functions of the constituents such as the communication unit 21, the positioning unit 22, the storage unit 23, the display unit 24, and the input unit 25.

The function of the terminal device 20 is realized by causing a processor of a computer to execute a program according to this embodiment. That is, the function of the terminal device 20 is realized in software. The program is a program for causing a computer to realize functions corresponding to processes of steps by causing the computer to perform the processes of the steps included in the operation of the terminal device 20. That is, the program is a program for causing a computer to serve as the terminal device 20.

The program can be stored in a computer-readable non-transitory recording medium. The computer-readable non-transitory recording medium is, for example, a magnetic recording device, an optical disc, a magneto-optical recording medium, or a semiconductor memory. The program is distributed, for example, by selling, transferring, or lending a portable recording medium such as a digital versatile disc (DVD) or a compact-disc read only memory (CD-ROM) having the program recorded thereon. Alternatively, the program may be distributed by storing the program in a storage of a predetermined server and transmitting the program from the predetermined server to another computer. The program may be provided as a program product.

For example, the computer temporarily stores the program recorded on the portable recording medium or the program transmitted from the predetermined server in a memory. Then, the computer reads the program stored in the memory using a processor and causes the processor to perform processing based on the read program. The computer may directly read the program from the portable recording medium and perform processing based on the program. Whenever the program is transmitted from the predetermined server to the server, the computer may sequentially perform processing based on the received program. The processing may be performed by a so-called application service provider (ASP) type service in which transmission of a program from a predetermined server to a computer is not performed and the function is realized by only execution instruction and result acquisition. The program includes information which is provided for processing in a computer and which is based on the program. For example, data which is not a direct command to a computer but has characteristics for defining processing in the computer corresponds to the “information which is based on the program.”

Configuration of Control Device

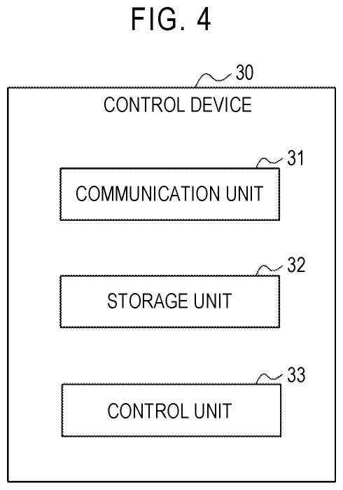

The configuration of a control device 30 according to this embodiment will be described with reference to FIG. 4. As illustrated in the block diagram of FIG. 4, the control device 30 includes a communication unit 31, a storage unit 32, and a control unit 33. The communication unit 31, the storage unit 32, and the control unit 33 are communicatively connected to each other in a wired or wireless manner.

The communication unit 31 includes a communication module for connecting to the network 40. The communication module is, for example, a communication module corresponding to a mobile communication standard such as 4G or 5G. The communication module may be, for example, a communication module corresponding to a standard such as a wired LAN or a wireless LAN. The communication module may be a communication module corresponding to a short-range radio communication standard such as Wi-Fi, Bluetooth, or infrared communication. In this embodiment, the control device 30 is connected to the network 40 via the communication unit 31. Accordingly, the control device 30 can communicate with the vehicle 10 and the terminal device 20.

The storage unit 32 is, for example, a semiconductor memory, a magnetic memory, or an optical memory. The storage unit 32 may serve as, for example, a main storage device, an auxiliary storage device, or a cache storage device. The storage unit 32 stores arbitrary information which is used for operation of the control device 30. For example, the storage unit 32 may store a system program, an application program, embedded software, and a database. For example, information stored in the storage unit 32 may be updated with information which is acquired from the network 40 via the communication unit 31.

The control unit 33 includes one or more processors. Each processor may be, for example, a general-purpose processor such as a CPU or a dedicated processor specialized in a specific process. The control unit 33 is not limited to the processor and may include one or more dedicated circuits. Each dedicated circuit may be, for example, an FPGA or an ASIC. The control unit 33 controls the constituents in order to realize the function of the control device 30 including the functions of the constituents such as the communication unit 31 and the storage unit 32.

The function of the control device 30 is realized by causing a processor of a computer to execute a program according to this embodiment. That is, the function of the control device 30 is realized in software. The program is a program for causing a computer to realize functions corresponding to processes of steps by causing the computer to perform the processes of the steps included in the operation of the control device 30. That is, the program is a program for causing a computer to serve as the control device 30.

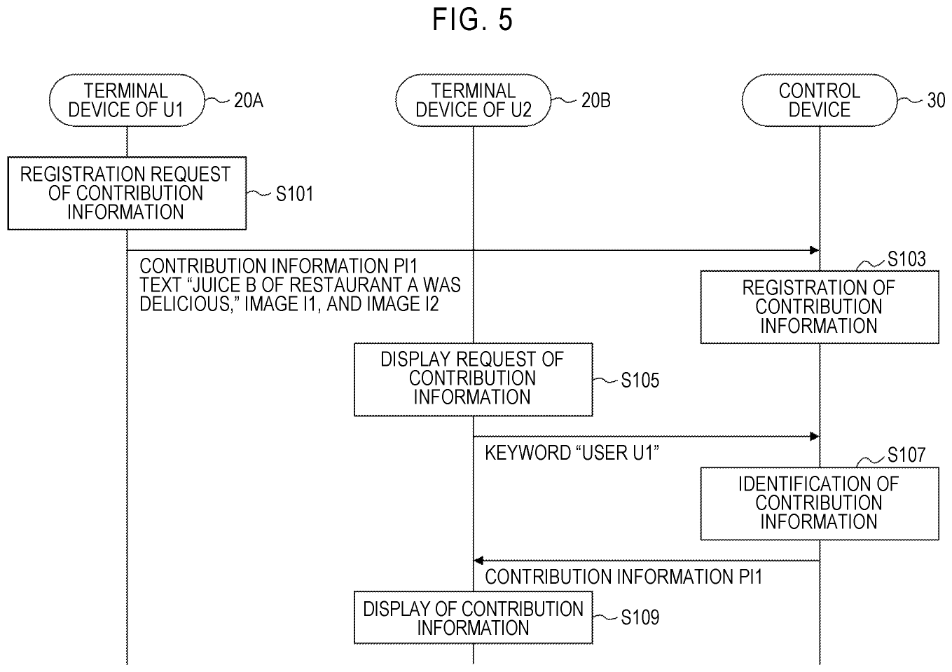

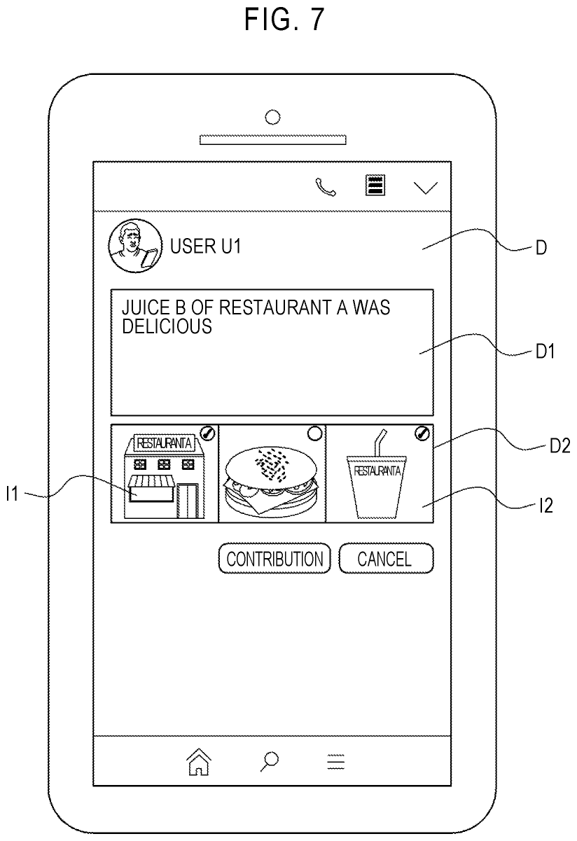

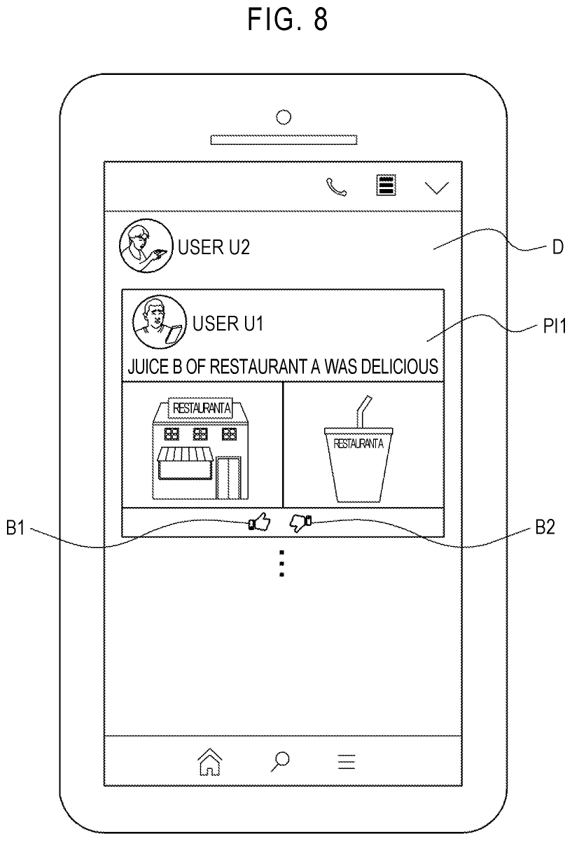

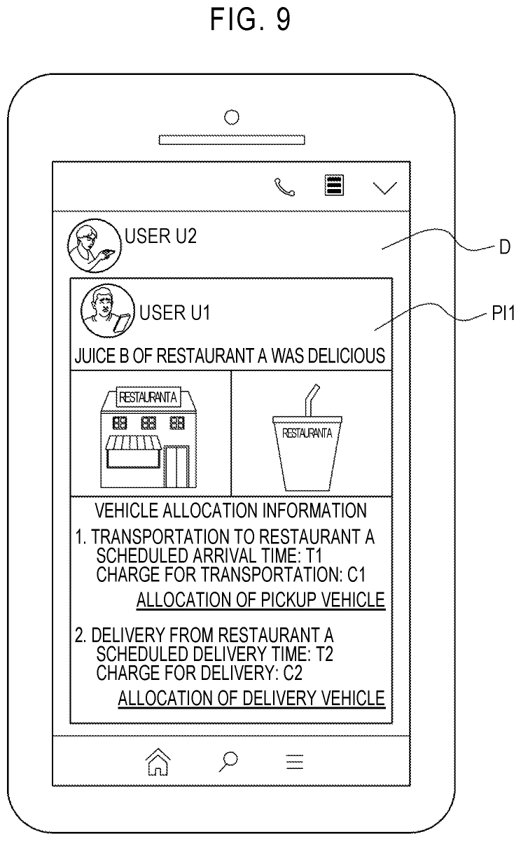

An operation of the information processing system 1 according to this embodiment will be described below with reference to FIGS. 5, 6, 7, 8, and 9. This operation corresponds to an information processing method according to this embodiment. In the information processing system 1, for example, it is assumed that a user U1 contributes contribution information PH using a terminal device 20A and a user U2 browses the contribution information PI1 using a terminal device 20B. FIG. 7 illustrates an example of a screen which is displayed on the terminal device 20A of the user U1 FIGS. 8 and 9 illustrate an example of a screen which is displayed on the terminal device 20B of the user U2.

A flow of processes of contributing contribution information will be first described below based on the operation of the terminal device 20A of the user U1.

As illustrated in FIG. 5, in Step S101, the control unit 26 of the terminal device 20A of the user U1 generates contribution information. Specifically, the control unit 26 of the terminal device 20A receives an operation of inputting at least one of text and an image from the user U1 via the input unit 25. The control unit 26 of the terminal device 20A generates contribution information including at least one of text and an image which has been input. The control unit 26 of the terminal device 20A transmits a registration request of contribution information including the generated contribution information to the control device 30 via the communication unit 21.

In this embodiment, as illustrated in FIG. 7, the control unit 26 of the terminal device 20A displays a screen for allowing the user U1 to input text and an image on a touch panel display D serving as both the display unit 24 and the input unit 25. The screen includes a text area D1 for displaying input text and an image area D2 for selecting an image to contribute. The user U1 operates the touch panel display D to input text “Juice B of Restaurant A was delicious” and to select an image I1 of restaurant A and an image I2 of juice B. The control unit 26 of the terminal device 20A generates contribution information PI1 including the input text, the image I1, and the image I2. The control unit 26 of the terminal device 20A transmits a registration request of contribution information including the generated contribution information PI1 to the control device 30.

Referring back to FIG. 5, in Step S103, the control unit 33 of the control device 30 registers the contribution information included in the received registration request of contribution information. Specifically, the control unit 33 receives the registration request of contribution information transmitted in Step S101 via the communication unit 31. The control unit 33 stores the contribution information included in the received registration request as one or more pieces of contribution information contributed by the user U1 in the storage unit 32. Accordingly, the contribution information received by the control unit 33 of the control device 30 is registered as information of the SNS and can be browsed using the terminal device 20. A process of registering the contribution information received by the control unit 33 of the control device 30 may be performed through the same registration process as in the SNS in the related art.

In this embodiment, the control unit 33 of the control device 30 receives the registration request of contribution information including contribution information PI1 including the text “Juice B of Restaurant A was delicious,” the image I1 of restaurant A, and the image I2 of juice B from the terminal device 20A of the user U1. The control unit 33 stores the contribution information PI1 included in the received registration request of contribution information as one or more pieces of contribution information contributed by the user U1 in the storage unit 32.

A flow of processes of browsing contribution information based on an operation of the user U2 on the terminal device 20B will be described next.

As illustrated in FIG. 5, in Step S105, the control unit 26 of the terminal device 20B of the user U2 generates a display request of contribution information. The display request of contribution information may include, for example, user information for identifying a user such as a log-in identifier (ID) and a password of the user U2 input via the input unit 25. An ID is also referred to as identification information. The display request of contribution information may include designation information for designating contribution information of which display is desired by a user such as a keyword preset by the user U2 and a date. The control unit 26 of the terminal device 20B transmits the generated display request of contribution information to the control device 30 via the communication unit 21.

In this embodiment, it is assumed that the user U2 presets “user U1” as a keyword for identifying contribution information of which display is desired. Accordingly, the control unit 26 of the terminal device 20B generates a display request of contribution information including user information of the user U2 and the keyword “user U1.” The control unit 26 of the terminal device 20B transmits the generated display request to the control device 30.

In Step S107, the control unit 33 of the control device 30 identifies one or more pieces of contribution information in response to the received display request of contribution information. Specifically, the control unit 33 receives the display request transmitted in Step S105 via the communication unit 31. The control unit 33 stores the received display request as one or more display requests transmitted by the user U2 in the storage unit 32. The control unit 33 identifies one or more pieces of contribution information which are transmitted to the user U2 based on the received display request. The control unit 33 transmits the identified one or more pieces of contribution information to the terminal device 20B of the user U2 via the communication unit 31.

In this embodiment, the control unit 33 of the control device 30 stores a display request of contribution information including a keyword “user U1” received from the terminal device 20B of the user U2 as one or more display requests transmitted by the user U2 in the storage unit 32. The control unit 33 identifies one or more pieces of contribution information including the contribution information PI1 registered by the user U1 in Step S101 based on the keyword “user U1.” The control unit 33 transmits the identified one or more pieces of contribution information to the terminal device 20B of the user U2 via the communication unit 31.

In Step S109, the control unit 26 of the terminal device 20B of the user U2 displays the received one or more pieces of contribution information. Specifically, the control unit 26 receives one or more pieces of contribution information transmitted in Step S107 via the communication unit 21. The control unit 26 displays the received one or more pieces of contribution information using the display unit 24.

In this embodiment, the control unit 26 of the terminal device 20B of the user U2 receives one or more pieces of contribution information including the contribution information PI1 from the control device 30. As illustrated in FIG. 8, the control unit 26 displays the received contribution information PI1 of the user UI on the touch panel display D. In this embodiment, only one piece of contribution information PI1 is displayed on the touch panel display D, but a plurality of pieces of contribution information may be displayed thereon. When a plurality of pieces of contribution information is displayed, the control unit 26 may display the received contribution information, for example, in descending order of registration dates and times.

A flow of processes of displaying vehicle allocation information based on a response from the user U2 of the terminal device 20B responsive to the contribution information PI1 will be described below.

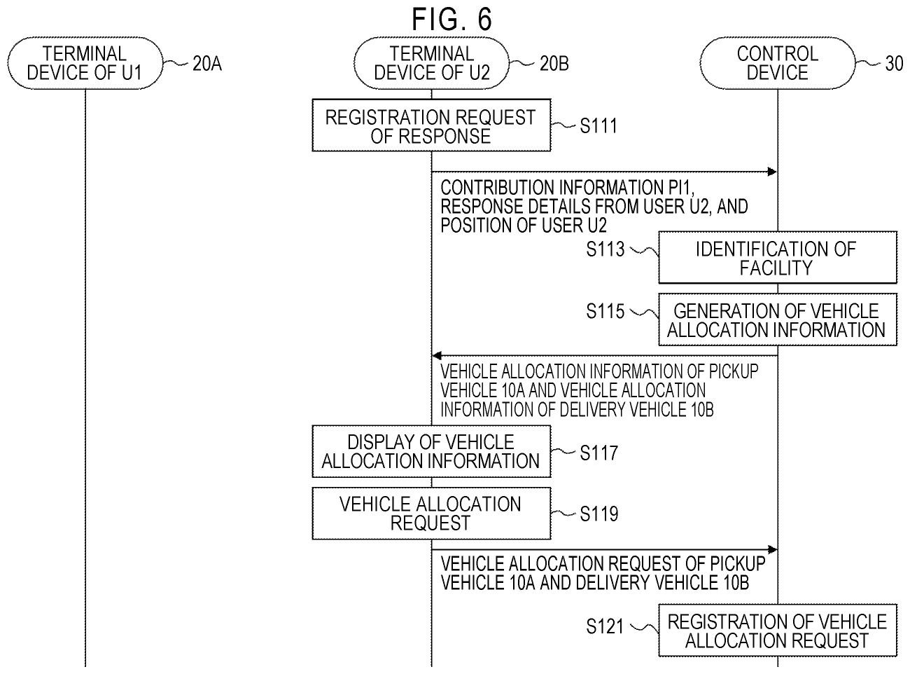

As illustrated in FIG. 6, in Step S111, the control unit 26 of the terminal device 20B of the user U2 generates a response of the user U2. The response of the user U2 includes, for example, information for designating contribution information, response details, and position information of the user U2. The information for designating contribution information is information for uniquely identifying contribution information and is, for example, a contribution information ID. The response details are information which is input by the user U2. For example, the control unit 26 receives an operation of clicking a button, inputting text, or the like via the input unit 25 and stores the input information as response details. The position information of the user U2 is information indicating a point at which the user is located. For example, the control unit 26 may measure the position of the terminal device 20B using the positioning unit 22 and use coordinates such as generated two-dimensional coordinates or three-dimensional coordinates as the position information of the user U2. The control unit 26 of the terminal device 20B transmits a registration request of a response including the generated response of the user U2 to the control device 30 via the communication unit 21.

In this embodiment, as illustrated in FIG. 8, the control unit 26 of the terminal device 20B displays a response button for allowing the user U2 to input a response along with the contribution information PI1 on the touch panel display D. The response button includes a thumbs-up button B1 and a thumbs-down button B2. When the thumbs-up button B1 or the thumbs-down button B2 of the contribution information PI1 is clicked by the user U2, the control unit 26 generates a response of the user U2 to the contribution information PI1. When the thumbs-up button B1 of the contribution information PI1 is clicked, the control unit 26 stores clicking of the thumbs-up button B1 as response details indicating that the user U2 is interested in the contribution information PI1. When the thumbs-down button B2 of the contribution information PI1 is clicked, the control unit 26 stores the clicking of the thumbs-down button B2 as response details indicating that the user U2 is not interested in the contribution information PI1. The control unit 26 generates coordinates of the terminal device 20B as position information of the user U2 using the positioning unit 22. The control unit 26 generates a response of the user U2 including the information designating the contribution information PI1, the response details, and the position information of the user U2. The control unit 26 of the terminal device 20B transmits a registration request of a response including the generated response of the user U2 to the control device 30. In the following description, it is assumed that the thumbs-up button B1 is clicked by the user U2 and the response of the user U2 includes the response details indicating that the user U2 is interested in the contribution information PI1.

Referring back to FIG. 6, in Step S113, the control unit 33 of the control device 30 identifies a facility in which a user can be interested based on contribution information contributed to the SNS and a response of the user with respect to the contribution information.

In Step S113, the control unit 33 receives the registration request of a response of the user U2 with respect to the contribution information transmitted in Step S111 via the communication unit 31. The control unit 33 may store the response of the user U2 with respect to the contribution information included in the received registration request of a response in the storage unit 32. The control unit 33 determines whether the response of the user U2 includes information indicating that the user U2 is interested in the contribution information. In the following description, a “response including information indicating that a user is interested” is also referred to as a “response indicating that a user is interested.” When the response includes the information indicating that the user U2 is interested in the contribution information, the control unit 33 performs subsequent processes. The control unit 33 may determine whether the number of responses indicating that a user is interested and registered with respect to the contribution information is equal to or greater than a predetermined number. When the number of responses indicating that a user is interested and registered with respect to the contribution information is equal to or greater than a predetermined number, the control unit 33 may perform subsequent processes. The predetermined number is, for example, the number of responses indicating that a user is interested in the contribution information PI1, but may be a ratio of the number of responses indicating that a user is interested in the contribution information PI1 to the total number of responses to the contribution information PI1.

In this embodiment, since the response of the user U2 with respect to the contribution information PI1, which has been received from the terminal device 20B, includes the response details indicating that the user U2 is interested in the contribution information PI1, the control unit 33 of the control device 30 performs subsequent processes.

In Step S113, the control unit 33 determines whether the contribution information includes at least one of information indicating a facility and information indicating a product which is provided from the facility as a subsequent process.

Specifically, when the contribution information includes text, the control unit 33 determines whether the contribution information includes at least one of text indicating a facility and text indicating a product which is provided from the facility by natural language processing. For example, text indicating a facility may include a name, an appearance feature, a location, a building name, or an employee name of the facility. For example, text indicating a product which is provided from a facility may include a name, an appearance feature, a genre, usage, or a price of the product. When it is determined that the contribution information includes text indicating a facility, the control unit 33 identifies the facility based on the text. When it is determined that the contribution information includes text indicating a product which is provided from a facility, the control unit 33 identifies the facility from which the product is provided based on the text. In this embodiment, the control unit 33 identifies the facility by identifying facility information such as a name or a position of the facility. The position of the facility is identified, for example, by an address or coordinates. The control unit 33 stores facility information of the identified facility in the storage unit 32 in correlation with the contribution information.

When the contribution information includes an image, the control unit 33 determines whether the contribution information includes at least one of an image indicating a facility and an image indicating a product which is provided from the facility by image processing. An image indicating a facility may include, for example, an image in which at least a part of the facility appears or an image in which information identifying a name or a location of the facility appears. An image indicating a product which is provided from a facility may include, for example, an image in which at least a part of the product appears or an image in which a name of the product appears. When it is determined that the contribution information includes an image indicating a facility, the control unit 33 identifies the facility based on the image. When it is determined that the contribution information includes an image indicating a product which is provided from the facility, the control unit 33 identifies the facility from which the product is provided based on the image. The control unit 33 stores facility information of the identified facility in the storage unit 32 in correlation with the contribution information.

In this embodiment, the control unit 33 of the control device 30 analyzes text “Juice B of Restaurant A was delicious” which is included in the contribution information PI1 designated by the response of the user U2 received from the terminal device 20B. By natural language processing, the control unit 33 extracts “restaurant A” as text indicating the facility and extracts “juice B” as text indicating a product which is provided from the facility. The control unit 33 of the control device 30 analyzes an image I1 of restaurant A and an image I2 of juice B which are included in the contribution information PI1. By image processing, the control unit 33 extracts an appearance of restaurant A from the image I1 and extracts an appearance of a container of juice B from the image I2. The control unit 33 searches a database or the Internet based on the extracted information and identifies restaurant A which provides juice B as a facility associated with the contribution information PI1. The control unit 33 stores the identified facility “restaurant A” as a facility associated with the contribution information PI1 in the storage unit 32.

In this embodiment, an example in which the contribution information PI1 includes all of text indicating a facility, an image indicating a facility, text indicating a product, and an image indicating a product has been described above. However, the contribution information may not include all of such information. In this case, the control unit 33 of the control device 30 may identify a facility based on at least one of information indicating the facility and information indicating a product provided from the facility which are included in the contribution information.

In Step S115, the control unit 33 of the control device 30 generates vehicle allocation information for proposing allocation of a vehicle 10. In the following description, “vehicle allocation information for proposing allocation” of a vehicle 10 is also referred to as “vehicle allocation information” of the vehicle 10. The control unit 33 generates vehicle allocation information of a pickup vehicle 10A that transports the user U2 to the facility and vehicle allocation information of a delivery vehicle 10B that delivers a product provided from the facility from the facility as vehicle allocation information of a vehicle 10. In this embodiment, the control unit 33 generates vehicle allocation information of both a pickup vehicle 10A and a delivery vehicle 10B, but may generate vehicle allocation information of only one as vehicle allocation information of a vehicle 10. The control unit 33 transmits the generated vehicle allocation information of a vehicle 10 to the terminal device 20 via the communication unit 31.

Specifically, the control unit 33 of the control device 30 generates vehicle allocation information of a pickup vehicle 10A with the position of the user U2 as a departure place and with the position of the facility as a destination. The control unit 33 acquires information of the pickup vehicle 10A which is available. In this embodiment, it is assumed that the control unit 33 stores information of the pickup vehicle 10A which is available in the storage unit 32 in advance. When there is a plurality of pickup vehicles 10A which is available, the control unit 33 may acquire information of a pickup vehicle 10A which is closest to the position of the user U2. Information of a pickup vehicle 10A includes, for example, a model, a registration number, and a position of the pickup vehicle 10A The control unit 33 generates a travel route R1 of the pickup vehicle 10A that transports the user U2 from the position of the user U2 to the position of the facility based on the acquired position of the pickup vehicle 10A, the position of the user U2, and the position of the facility. The control unit 33 calculates a scheduled arrival time T1 at which the pickup vehicle 10A arrives as the position of the facility and a charge C1 for transportation using the pickup vehicle 10A based on the generated travel route R1 of the pickup vehicle 10A. The control unit 33 stores the generated travel route R1 of the pickup vehicle 10A, the scheduled arrival time T1, and the charge C1 as vehicle allocation information of the pickup vehicle 10A in the storage unit 32.

The control unit 33 of the control device 30 generates vehicle allocation information of a delivery vehicle 10B with the position of the facility as a departure place and with the position of the user U2 as a destination. The control unit 33 acquires information of the delivery vehicle 10B which is available. In this embodiment, it is assumed that the control unit 33 stores information of a delivery vehicle 10B which is available in the storage unit 32 in advance. When there is a plurality of delivery vehicles 10B which is available, the control unit 33 may acquire information of a delivery vehicle 10B which is closest to the position of the facility. Information of a delivery vehicle 10B includes, for example, a model, a registration number, and a position of the delivery vehicle 10B. The control unit 33 generates a travel route R2 of the delivery vehicle 10B that delivers a product which is provided from the facility from the position of the facility to the position of the user U2 based on the acquired position of the delivery vehicle 10B, the position of the user U2, and the position of the facility. The control unit 33 calculates a scheduled delivery time T2 at which the delivery vehicle 10B arrives at the position of the user U2 and a charge C2 for delivery using the delivery vehicle 10B based on the generated travel route R2 of the delivery vehicle 10B. The control unit 33 stores the travel route R2 of the delivery vehicle 10B, the scheduled delivery time T2, and the charge C2 as vehicle allocation information of the delivery vehicle 10B in the storage unit 32.

The control unit 33 of the control device 30 transmits the vehicle allocation information of the pickup vehicle 10A and the vehicle allocation information of the delivery vehicle 10B to the terminal device 20B of the user U2 via the communication unit 31. The control unit 33 may transmit an instruction to display the vehicle allocation information along with the contribution information to the terminal device 20 via the communication unit 31 in addition to the vehicle allocation information.

In this embodiment, the control unit 33 of the control device 30 generates vehicle allocation information of the pickup vehicle 10A and the delivery vehicle 10B based on position information of the user U2 included in the registration request of a response of the user U2 with respect to the contribution information PI1 transmitted in Step S111 and the position of the facility identified in Step S113. The control unit 33 transmits an instruction to display the scheduled arrival time T1 and the charge C1 included in the vehicle allocation information of the pickup vehicle 10A and the scheduled delivery time T2 and the charge C2 included in the vehicle allocation information of the delivery vehicle 10B as vehicle allocation information along with the contribution information PI1 to the terminal device 20B of the user U2.

In Step S117, the control unit 26 of the terminal device 20B of the user U2 receives the vehicle allocation information transmitted in Step S115 via the communication unit 21. The control unit 26 displays the received vehicle allocation information along with the contribution information on the display unit 24.

In this embodiment, the control unit 26 of the terminal device 20B of the user U2 receives the scheduled arrival time T1 and the charge C1 included in the vehicle allocation information of the pickup vehicle 10A and the scheduled delivery time T2 of the delivery vehicle 10B and the charge C2 included in the vehicle allocation information of the delivery vehicle 10B from the control device 30. As illustrated in FIG. 9, the control unit 26 displays the received scheduled arrival time T1 and the received charge C1 included in the vehicle allocation information of the pickup vehicle 10A and the received scheduled delivery time T2 and the received charge C2 included in the vehicle allocation information of the delivery vehicle 10B on the touch panel display D along with the contribution information PI1.

Referring back to FIG. 6, in Step S119, the control unit 26 of the terminal device 20B of the user U2 generates a vehicle allocation request. The vehicle allocation request may include, for example, information for designating the vehicle allocation information of the pickup vehicle 10A in order to request allocation of the pickup vehicle 10A. The vehicle allocation request may include, for example, information for designating the vehicle allocation information of the delivery vehicle 10B in order to request allocation of the delivery vehicle 10B. The control unit 26 of the terminal device 20B transmits the generated vehicle allocation request to the control device 30 via the communication unit 21.

In this embodiment, as illustrated in FIG. 9, the control unit 26 of the terminal device 20B displays a link “allocation of pickup vehicle” and a link “allocation of delivery vehicle” on the touch panel display D along with the vehicle allocation information of the contribution information PI1. When the link “allocation of pickup vehicle” is clicked by the user U2, the control unit 26 generates a vehicle allocation request of the pickup vehicle 10A. When the link “allocation of delivery vehicle” is clicked by the user U2, the control unit 26 generates a vehicle allocation request of the delivery vehicle 10B. The control unit 26 transmits the vehicle allocation request of the pickup vehicle 10A or the delivery vehicle 10B to the control device 30.

In Step S121, the control unit 33 of the control device 30 registers the received vehicle allocation request of the pickup vehicle 10A or the delivery vehicle 10B. Specifically, the control unit 33 receives the vehicle allocation request transmitted in Step S119 via the communication unit 31. The control unit 33 stores the received vehicle allocation request as one or more vehicle allocation requests transmitted from the user U2 in the storage unit 32. When the received vehicle allocation request is the vehicle allocation request of the pickup vehicle 10A, the control unit 33 may perform a process of allocating the pickup vehicle 10A based on the generated vehicle allocation information of the pickup vehicle 10A. When the received vehicle allocation request is the vehicle allocation request of the delivery vehicle 10B, the control unit 33 may perform a process of allocating the delivery vehicle 10B based on the generated vehicle allocation information of the delivery vehicle 10B. After the process of allocating the pickup vehicle 10A or the delivery vehicle 10B has been completely performed, the control unit 33 may perform a process of charging the user U2 for the vehicle allocation by electronic payment or the like.

As described above, the control device 30 according to this embodiment includes the communication unit 31 and the control unit 33. The communication unit 31 communicates with a terminal device 20. The control unit 33 transmits vehicle allocation information for proposing allocation of at least one of a pickup vehicle 10A for transporting a user to a facility and a delivery vehicle 10B for delivering a product from the facility to the terminal device 20 via the communication unit 31 based on contribution information which is contributed to a social networking service and a response from a user of the terminal device 20 with respect to the contribution information. With this configuration, the control device 30 can provide a user with vehicle allocation information of a vehicle 10 associated with information of the SNS to which the user has responded. Accordingly, the control device 30 can improve serviceability of the technique of allocating a vehicle 10.

In the control device 30 according to this embodiment, the control unit 33 can determine whether the response from the user includes information indicating that the user is interested in the contribution information and transmit the vehicle allocation information to the terminal device 20 via the communication unit 31 when the response includes the information indicating that the user is interested in the contribution information. With this configuration, when the user does not contribute a response indicating that the user is interested in the contribution information, the control device 30 does not provide vehicle allocation information and can decrease a possibility that unnecessary vehicle allocation information will be provided to the user.

In the control device 30 according to this embodiment, the control unit 33 can determine whether the number of registered responses to the contribution information, which indicate that a user is interested in the contribution information, is equal to or greater than a predetermined number, and transmit the vehicle allocation information to the terminal device 20 via the communication unit 31 when the number of responses indicating that the user is interested in the contribution information is equal to or greater than the predetermined number. With this configuration, the control device 30 can decrease a possibility that unnecessary vehicle allocation information will be provided to the user by providing the vehicle allocation information only when a large number of users are interested in the contribution.

In the control device 30 according to this embodiment, the control unit 33 can identify a facility based on the text in the contribution information indicating the facility. With this configuration, in the control device 30, it is possible to decrease a user's burden of setting a position of a facility as a departure place or a destination by identifying a position of a facility in which a user is interested based on the text included in the contribution information contributed to the SNS.

In the control device 30 according to this embodiment, the control unit 33 can identify a facility based on an image in the contribution information indicating the facility. With this configuration, it is possible for the control device 30 to decrease a user's burden of setting a position of a facility as a departure place or a destination by identifying a position of a facility in which a user is interested based on an image included in the contribution information contributed to the SNS.

In the control device 30 according to this embodiment, the control unit 33 can identify a facility based on the text in the contribution information indicating a product which is provided from the facility. With this configuration, it is possible for the control device 30 to decrease a user's burden of setting a position of a facility as a departure place or a destination by identifying a position of a facility in which a user is interested and from which a product is provided based on the text included in the contribution information contributed to the SNS.

In the control device 30 according to this embodiment, the control unit 33 can identify a facility based on an image in the contribution information indicating a product which is provided from the facility. With this configuration, it is possible for the control device 30 to decrease a user's burden of setting a position of a facility as a departure place or a destination by identifying a position of a facility in which a user is interested and from which a product is provided based on an image included in the contribution information contributed to the SNS.

In the control device 30 according to this embodiment, the control unit 33 can generate vehicle allocation information of the pickup vehicle 10A with a position of the user as a departure place and with a position of the facility as a destination. With this configuration, the control device 30 can propose allocation of the pickup vehicle 10A for a facility in which the user is interested based on the contribution information contributed to the SNS.

In the control device 30 according to this embodiment, the control unit 33 can generate vehicle allocation information of the delivery vehicle 10B with a position of the facility as a departure place and with a position of the user as a destination. With this configuration, the control device 30 can propose allocation of the delivery vehicle 10B for a facility in which the user is interested based on the contribution information contributed to the SNS.

In the control device 30 according to this embodiment, the control unit 33 can transmit an instruction for displaying the vehicle allocation information along with the contribution information to the terminal device 20 via the communication unit 31. With this configuration, the control device 30 can provide the vehicle allocation information of a vehicle 10 associated with contribution information which a user browses to the terminal device 20 along with the contribution information.

A terminal device 20 according to this embodiment includes a control unit 26 configured to perform control for displaying vehicle allocation information for proposing allocation of at least one of a pickup vehicle 10A for transporting a user to a facility and a delivery vehicle 10B for delivering a product from the facility based on contribution information which is contributed to a social networking service and a response from a user of the terminal device 20 to the contribution information. With this configuration, the terminal device 20 can provide a user with vehicle allocation information of a vehicle 10 associated with information of the SNS to which the user has responded. Accordingly, the terminal device 20 can improve serviceability of the technique of allocating a vehicle 10.

While the disclosure has been described with reference to all the drawings and embodiments, those skilled in the art should note that various modifications and corrections can be embodied based on the disclosure. Accordingly, it should be noted that these modifications and corrections are included in the scope of the disclosure. For example, the functions included in the means or steps and the like can be rearranged unless logical confliction arises, and a plurality of means or steps and the like can be combined into a single means or step or each thereof can be divided into a plurality of means or steps.

For example, in the aforementioned embodiment, the control unit 26 of the terminal device 20 transmits a response of a user including response details corresponding to the thumbs-up button B1 or the thumbs-down button B2 in the contribution information displayed on the display unit 24 to the control device 30. However, the control unit 26 of the terminal device 20 may receive an operation of allowing a user to input text as response details via the input unit 25. The control unit 26 may transmit a registration request of the response of the user including the text input via the input unit 25 to the control device 30. In this case, the control unit 33 of the control device 30 may determine whether the response included in the received registration request includes information indicating that the user is interested in the contribution information by natural language processing.

In the aforementioned embodiment, all or some of the functions or processes which have been described above as the functions or processes of the terminal device 20 or the control device 30 may be embodied as functions or processes of a general-purpose computer such as a smartphone or a personal computer. Specifically, a program in which processing details for realizing the functions of the terminal device 20 or the control device 30 according to the embodiments are described can be stored in a memory of a computer, and the program can be read and executed by a processor of the computer. Accordingly, the disclosure of the embodiments can also be embodied as a program which can be executed by a processor. For example, a vehicle 10 may serve as the terminal device 20 or the control device 30. In this case, the vehicle 10 may be provided with a computer having the aforementioned configurations and functions as the configurations and functions of the terminal device 20 or the control device 30.

In the aforementioned embodiment, the terminal device 20 may be configured such that the terminal device 20 performs some or all of the operations and processes which are performed by the control device 30. For example, the information processing system 1 may not include the control device 30. In this case, the terminal device 20 may be configured to perform all of the operations and processes which are performed by the terminal device 20 and the control device 30 in the aforementioned embodiments.

In the aforementioned embodiment, the SNS is a service in which users share information by contributing and browsing information including an image or text. However, the SNS may be a chat service in which a plurality of users contributes and browses messages. In this case, the control unit 33 of the control device 30 generates a message including vehicle allocation information for proposing allocation of at least one of a pickup vehicle 10A and a delivery vehicle 10B based on a message which has been contributed to a chat room by one of a plurality of users participating in chatting as contribution information to the SNS and a response of another user to the message. The control unit 33 may display the message including vehicle allocation information, for example, as an interrupt message from a chatbot in the chat room.

When it is determined that the number of responses indicating that a user is interested in a message which has been contributed by one of the users participating in chatting and which includes text or an image indicating a facility or a product provided from the facility is equal to or greater than a predetermined number (for example, more than fifty percent), the control unit 33 of the control device 30 may display a message including vehicle allocation information associated with the message in the chat room.

The control unit 33 of the control device 30 may display the message including vehicle allocation information in the chat room such that all the users participating in chatting can browse the message. Alternatively, the control device 30 may display the message including vehicle allocation information in the chat room such that only users having contributed a response indicating that the users are interested out of the users participating in chatting can browse the message. The control device 30 may display the message including vehicle allocation information in the chat room such that only the users registered to receive vehicle allocation information in advance out of the users having contributed a response indicating that the corresponding user is interested in the message can browse the message.

In the aforementioned embodiment, the control unit 33 of the control device 30 performs a process of charging the user U2 for vehicle allocation by electronic payment or the like after the process of allocating a vehicle 10 has been completed in response to a vehicle allocation request of the vehicle 10 from the user U2. However, when the SNS is a chat service, the control unit 33 of the control device 30 may determine a user out of the users participating in chatting who is to be charged for vehicle allocation and perform the charging process on the determined user. For example, the control unit 33 of the control device 30 may perform a process of equally charging for vehicle allocation all the users having contributed a response indicating that the corresponding user is interested out of the users participating in chatting.

What is claimed is:

1. A control device comprising:
a communication unit configured to communicate with a terminal device; and
a control unit configured to transmit vehicle allocation information for proposing allocation of at least one of a pickup vehicle for transporting a user to a facility and a delivery vehicle for delivering a product from the facility to the terminal device via the communication unit based on contribution information which is contributed to a social networking service and a response from the user of the terminal device to the contribution information.

2. The control device according to claim 1, wherein the control unit is configured to determine whether the response from the user includes information indicating that the user is interested in the contribution information and to transmit the vehicle allocation information to the terminal device via the communication unit when the response includes the information indicating that the user is interested in the contribution information.

3. The control device according to claim 1, wherein the control unit is configured to determine whether the number of registered responses to the contribution information indicating that a user is interested in the contribution information is equal to or greater than a predetermined number and to transmit the vehicle allocation information to the terminal device via the communication unit when the number of responses indicating that a user is interested in the contribution information is equal to or greater than the predetermined number.

4. The control device according to claim 1, wherein the control unit is configured to identify a facility based on text in the contribution information indicating the facility.

5. The control device according to claim 1, wherein the control unit is configured to identify a facility based on an image in the contribution information indicating the facility.

6. The control device according to claim 1, wherein the control unit is configured to identify a facility based on text in the contribution information indicating a product which is provided from the facility.

7. The control device according to claim 1, wherein the control unit is configured to identify a facility based on an image in the contribution information indicating a product which is provided from the facility.

8. The control device according to claim 1, wherein the control unit is configured to generate vehicle allocation information of the pickup vehicle with a position of the user as a departure place and with a position of the facility as a destination.

9. The control device according to claim 1, wherein the control unit is configured to generate vehicle allocation information of the delivery vehicle with a position of the facility as a departure place and with a position of the user as a destination.

10. The control device according to claim 1, wherein the control unit is configured to transmit an instruction for displaying the vehicle allocation information along with the contribution information to the terminal device via the communication unit.

11. A program causing a computer to serve as a control device comprising:
a communication unit configured to communicate with a terminal device; and
a control unit configured to transmit vehicle allocation information for proposing allocation of at least one of a pickup vehicle for transporting a user to a facility and a delivery vehicle for delivering a product from the facility to the terminal device via the communication unit based on contribution information which is contributed to a social networking service and a response from the user of the terminal device to the contribution information.

12. The program according to claim 11, wherein the control unit is configured to determine whether the response from the user includes information indicating that the user is interested in the contribution information and to transmit the vehicle allocation information to the terminal device via the communication unit when the response includes the information indicating that the user is interested in the contribution information.

13. The program according to claim 11, wherein the control unit is configured to determine whether the number of registered responses to the contribution information indicating that a user is interested in the contribution information is equal to or greater than a predetermined number and to transmit the vehicle allocation information to the terminal device via the communication unit when the number of responses indicating that a user is interested in the contribution information is equal to or greater than the predetermined number.

14. The program according to claim 11, wherein the control unit is configured to identify a facility based on at least one of text and an image in the contribution information indicating the facility.

15. The program according to claim 11, wherein the control unit is configured to identify a facility based on at least one of text and an image in the contribution information indicating a product which is provided from the facility.

16. The program according to claim 11, wherein the control unit is configured to generate vehicle allocation information of the pickup vehicle with a position of the user as a departure place and with a position of the facility as a destination.

17. The program according to claim 11, wherein the control unit is configured to generate vehicle allocation information of the delivery vehicle with a position of the facility as a departure place and with a position of the user as a destination.

18. The program according to claim 11, wherein the control unit is configured to transmit an instruction for displaying the vehicle allocation information along with the contribution information to the terminal device via the communication unit.

19. A program causing a computer to serve as a terminal device comprising:
a control unit configured to perform control for displaying vehicle allocation information for proposing allocation of at least one of a pickup vehicle for transporting a user to a facility and a delivery vehicle for delivering a product from the facility based on contribution information which is contributed to a social networking service and a response from the user to the contribution information.

20. The program according to claim 19, wherein the control unit is configured to perform control for displaying the vehicle allocation information along with the contribution information.
